(19) United States
(12) Patent Application Publication
(10) Pub. No.: US 2025/0273129 A1
(43) Pub. Date: Aug. 28, 2025

(54) OUTPUT CONTROL CIRCUIT, GATE EMISSION DRIVER INCLUDING THE OUTPUT CONTROL CIRCUIT, AND DISPLAY APPARATUS INCLUDING THE OUTPUT CONTROL CIRCUIT

(71) Applicant: Samsung Display Co., LTD., Yongin-si (KR)

(72) Inventors: KYUNGHO KIM, Yongin-si (KR); NAHYEON CHA, Yongin-si (KR); SANG YONG NO, Yongin-si (KR)

(21) Appl. No.: 18/957,797

(22) Filed: Nov. 24, 2024

(30) Foreign Application Priority Data
Feb. 28, 2024 (KR) 10-2024-0028804

(51) Int. Cl. G09G 3/32

(52) U.S. Cl. CPC G09G 3/32; G09G 2300/0819; G09G 2300/0842; G09G 2300/0861; G09G 2310/0267; G09G 2310/08; G09G 2330/021

(57) ABSTRACT

An output control circuit may comprise an inverter circuit configured to convert an emission signal to an inverted emission signal and an outputting determining circuit configured to generate an output control signal based on an enable signal, the emission signal, and the inverted emission signal.

This application claims priority to Korean Patent Application No. 10-2024-0028804, filed on Feb. 28, 2024, and all the benefits accruing therefrom under 35 U.S.C. § 119, the content of which in its entirety is herein incorporated by reference.

### BACKGROUND

### 1. Field

Embodiments supported by aspects of the present disclosure relate to an output control circuit, a gate emission driver including the output control circuit, and a display apparatus including the output control circuit. More particularly, embodiments of the present disclosure relate to an output control circuit reducing power consumption and a gate emission driver including the output control circuit.

### 2. Description of the Related Art

Generally, a display apparatus includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines and a driving controller controlling the gate driver and the data driver.

When an image displayed on the display panel is a static image or the display panel is operated in always on mode, techniques for decreasing a driving frequency of the display panel to reduce power consumption may be desired.

When a portion of the image displayed on the display panel is a static image and a portion of the image displayed on the display panel is a moving image, techniques for reducing a driving frequency of the portion of the display panel corresponding to the static image to further reduce the power consumption may be desired.

However, in some cases, a stage of the gate driver may receive an output of a previous stage as a carry signal to output the gate signal, such that the driving frequency of some portions of the display panel may not be decreased.

### SUMMARY

Embodiments supported by aspects of the present disclosure provide a gate signal masking circuit supporting a multiple division of a driving frequency to reduce power consumption of the display apparatus.

Embodiments supported by aspects of the present disclosure also provide a gate emission driver including the gate signal masking circuit.

Embodiments supported by aspects of the present disclosure also provide a display apparatus including the gate emission driver.

According to embodiments, a gate emission driver may include a gate signal block and an output control signal block configured to control an outputting of the gate signal block. The gate signal block may include a first driver configured to generate a gate control signal and a carry signal based on a previous carry signal and a second driver configured to output a gate signal based on the gate control signal in response to an output control signal. The output control signal block may include an inverter circuit configured to convert an emission signal to an inverted emission signal and an output determining circuit configured to generate the output control signal based on an enable signal, the emission signal, and the inverted emission signal.

In an embodiment, the output determining circuit may include a first determining transistor including a control electrode configured to receive the emission signal, a first electrode configured to receive a first power voltage, and a second electrode connected to a first control node, a second determining transistor including a control electrode configured to receive the enable signal, a first electrode connected to the first control node, and a second electrode connected to a second control node, a third determining transistor including a control electrode configured to receive the enable signal, a first electrode connected to the second control node, and a second electrode connected to a third control node, and a fourth determining transistor including a control electrode configured to receive the inverted emission signal, a first electrode connected to the third control node, and a second electrode configured to receive a second power voltage lower than the first power voltage. The first determining transistor and the second determining transistor may each be a P-type transistor and the third determining transistor and the fourth determining transistor may each be an N-type transistor.

In an embodiment, the inverter circuit may include a first inverter transistor including a control electrode configured to receive the emission signal, a first electrode configured to receive the first power voltage, and a second electrode connected to a fourth control node and a second inverter transistor including a control electrode configured to receive the emission signal, a first electrode connected to the fourth control node, and a second electrode configured to receive the second power voltage. The first inverter transistor may be a P-type transistor and the second inverter transistor may be an N-type transistor.

In an embodiment, the output determining circuit may further include a control capacitor including a first electrode configured to receive a third power voltage different from the second power voltage, and a second electrode connected to the second control node.

In an embodiment, when the enable signal has a high level and the emission signal has a low level, the gate signal may have an activation level.

In an embodiment, when the enable signal has the high level and the emission signal has the low level, the output control signal may have a low level.

In an embodiment, when the enable signal has a low level and the emission signal has a high level, the gate signal may have an inactivation level.

In an embodiment, when the enable signal has the low level and the emission signal has the high level, the output control signal may have a high level.

In an embodiment, when the enable signal has a high level and the emission signal has a high level, the output control signal may maintain a previous level.

In an embodiment, when the enable signal has a low level and the emission signal has a low level, the output control signal may maintain a previous level.

In an embodiment, the gate signal may include an initialization gate signal. The second driver may include a first initialization output transistor including a control electrode configured to receive the output control signal, a first electrode connected to a second initialization control node, and a second electrode connected to a third initialization node, a second initialization output transistor including a control electrode connected to the third initialization node, a first electrode configured to receive a first power voltage, and a second electrode connected to a fourth initialization node and a third initialization output transistor including a control electrode connected to a first initialization control node, a first electrode connected to the fourth initialization node, and a second electrode configured to receive a second power voltage lower than the first power voltage. A signal of the fourth initialization node may be the initialization gate signal.

In an embodiment, wherein the first driver may include a first initialization carry transistor including a control electrode connected to the second initialization control node, a first electrode configured to receive the first power voltage, and a second electrode connected to a second initialization node and a second initialization carry transistor including a control electrode connected to the first initialization control node, a first electrode connected to the second initialization node, and a second electrode configured to receive the second power voltage. A signal of the second initialization node may be the carry signal.

In an embodiment, the gate signal may include a compensation gate signal. The second driver may include a first compensation output transistor including a control electrode configured to receive the output control signal, a first electrode connected to a second compensation control node, and a second electrode connected to a third compensation node, a second compensation output transistor including a control electrode connected to the third compensation node, a first electrode configured to receive a first power voltage and, a second electrode connected to a fourth compensation node and a third compensation output transistor including a control electrode connected to a first compensation control node, a first electrode connected to the fourth compensation node, and a second electrode configured to receive a second power voltage lower than the first power voltage. A signal of the fourth compensation node may be the compensation gate signal.

In an embodiment, the first driver may include a first compensation carry transistor including a control electrode connected to the second compensation control node, a first electrode configured to receive the first power voltage, and a second electrode connected to a second compensation node and a second compensation carry transistor including a control electrode connected to the first compensation control node, a first electrode connected to the second compensation node, and a second electrode configured to receive the second power voltage. A signal of the second compensation node may be the carry signal.

In an embodiment, the gate signal may include a write gate signal, and the gate control signal may include a first write gate control signal and a second write gate control signal. The second driver may include a first write output transistor including a control electrode configured to receive the output control signal, a first electrode configured to receive the first write gate control signal, and a second electrode connected to a first write output node, a second write output transistor including a control electrode configured to receive the second write gate control signal, a first electrode configured to receive a first power voltage, and a second electrode connected to a second write output node, and a third output transistor including a control electrode connected to the first write output node, a first electrode connected to the second write output node, and a second electrode configured to receive a second clock signal. A signal of the second write output node may be the write gate signal.

In an embodiment, the first driver may generate the gate control signal based on the previous carry signal and a first clock signal different from the second clock signal.

In an embodiment, the gate signal block further may include a next write gate signal outputter. The next write gate signal outputter may include a fourth write output transistor including a control electrode configured to receive the output control signal, a first electrode configured to receive the first write gate control signal, and a second electrode connected to a third write output node, a fifth write output transistor including a control electrode configured to receive the second write gate control signal, a first electrode configured to receive the first power voltage, and a second electrode connected to a fourth write output node and a sixth write output transistor including a control electrode connected to the third write output node, a first electrode connected to the fourth write output node, and a second electrode configured to receive a third clock signal. A signal of the fourth write output node may be a next write gate signal.

According to embodiments, a display apparatus may include a display panel including a pixel, a gate emission driver configured to output a gate signal and an emission signal to the display panel and a data driver configured to output a data voltage to the display panel. The gate emission driver may include a gate signal block and an output control signal block configured to control an outputting of the gate signal block. The gate signal block may generate a carry signal and the gate signal based on a previous carry signal and output the gate signal in response to an output control signal. The output control signal block may include an inverter circuit configured to convert the emission signal to an inverted emission signal and an outputting determining circuit configured to generate the output control signal based on an enable signal, the emission signal, and the inverted emission signal.

In an embodiment, the outputting determining circuit may include a first determining transistor including a control electrode configured to receive the emission signal, a first electrode configured to receive a first power voltage, and a second electrode connected to a first control node, a second determining transistor including a control electrode configured to receive the enable signal, a first electrode connected to the first control node, and a second electrode connected to a second control node, a third determining transistor including a control electrode configured to receive the enable signal, a first electrode connected to the second control node, and a second electrode connected to a third control node and a fourth determining transistor including a control electrode configured to receive the inverted emission signal, a first electrode connected to the third control node, and a second electrode configured to receive a second power voltage lower than the first power voltage. The first determining transistor and the second determining transistor may each be a P-type transistor and the third determining transistor and the fourth determining transistor may each be an N-type transistor.

In an embodiment, the gate emission driver may further include an emission signal block. The gate signal block may include a first gate signal block and a second gate signal block. The output control signal block may include a first output control signal block and a second output control signal block. The emission signal block, the first gate signal block, and the first output control signal block may be located on a first side. The second gate signal block and the second output control signal block may be located on a first side and a second side different from the first side.

In an embodiment, the emission signal block may be connected to the second output control signal block through an emission line.

According to embodiments, an output control circuit may include an inverter circuit configured to convert an emission signal to an inverted emission signal and an outputting determining circuit configured to generate an output control signal based on an enable signal, the emission signal, and the inverted emission signal.

In an embodiment, the outputting determining circuit may include a first determining transistor including a control electrode configured to receive the emission signal, a first electrode configured to receive a first power voltage, and a second electrode connected to a first control node, a second determining transistor including a control electrode configured to receive the enable signal, a first electrode connected to the first control node, and a second electrode connected to a second control node, a third determining transistor including a control electrode configured to receive the enable signal, a first electrode connected to the second control node, and a second electrode connected to a third control node and a fourth determining transistor including a control electrode configured to receive the inverted emission signal, a first electrode connected to the third control node, and a second electrode configured to receive a second power voltage lower than the first power voltage. The first determining transistor and the second determining transistor may each be a P-type transistor and the third determining transistor and the fourth determining transistor may each be an N-type transistor.

In an embodiment, when the enable signal has a high level and the emission signal has a low level, the output control signal may have a low level.

In an embodiment, when the enable signal has a low level and the emission signal has a high level, the output control signal may have a high level.

In an embodiment, when the enable signal has a high level and the emission signal has a high level, the output control signal may maintain a previous level.

In an embodiment, when the enable signal has a low level and the emission signal has a low level, the output control signal may maintain a previous level.

As described herein, according to the output control circuit, the gate emission driver including the output control circuit and the display apparatus including the output control circuit, an output of a gate signal may be controlled based on the enable signal and the emission signal. Accordingly, the multiple division of the driving frequency may be supported.

In some aspects, through the multiple division of the driving frequency, the power consumption of the display apparatus may be effectively reduced. In some aspects, the multiple division of the driving frequency of the gate signal having two or more pulses may be supported.

In some aspects, the output control circuit may generate the output control signal based on the enable signal and the emission signal. Accordingly, the output control signal block may be located on the first side and the second side different from the first side of the display panel.

In some aspects, the output control signal block located on the second side may output the output control signal stably.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the present disclosure.

FIG. 2 is a circuit diagram illustrating an example of a pixel of a display panel of FIG. 1.

FIG. 3 is a conceptual diagram illustrating an enable signal applied to the gate emission driver of FIG. 1 according to driving frequencies of portions of the display panel of FIG. 1.

FIG. 4 is a conceptual diagram illustrating the gate emission driver of FIG. 1. FIG. 4 is a block diagram illustrating a gate driver included in a display apparatus of FIG. 1.

FIG. 5 is a timing diagram illustrating input signals applied to the pixel of FIG. 2 in a data writing period.

FIG. 6 is a timing diagram illustrating input signals applied to the pixel of FIG. 2 in a self-scan period.

FIG. 7 is a circuit diagram illustrating an example of an output control signal block included in a gate emission driver of FIG. 1.

FIG. 8 is a table illustrating a status of an output signal according to an input signal of an output control signal block of FIG. 7.

FIG. 9 is a timing diagram illustrating input signals and an output signal of an output control signal block of FIG. 7 when a period when the emission signal maintains a high level is included in a high period of the enable signal.

FIG. 10 is a timing diagram illustrating input signals and an output signal of an output control signal block of FIG. 7 when a period when the emission signal changes from a high level to a low level is included in a low period of the enable signal.

FIG. 11 is a circuit diagram illustrating an example of an initialization gate signal block included in a gate emission driver of FIG. 1.

FIG. 12 is a timing diagram illustrating an example of input signals, output signals and node voltages of an initialization gate signal block of FIG. 11.

FIG. 13 is a timing diagram illustrating an example of input signals, output signals and node voltages of an initialization gate signal block of FIG. 11.

FIG. 14 is a circuit diagram illustrating an example of a compensation gate signal block included in a gate emission driver 300 of FIG. 1.

FIG. 15 is a timing diagram illustrating an example of input signals, output signals and node voltages of a compensation gate signal block of FIG. 14.

FIG. 16 is a timing diagram illustrating an example of input signals, output signals and node voltages of a compensation gate signal block of FIG. 14.

FIG. 17 is a circuit diagram illustrating an example of a write gate signal block included in a gate emission driver of FIG. 1.

FIG. 18 is a timing diagram illustrating an example of input signals, output signals and node voltages of a write gate signal block of FIG. 17.

FIG. 19 is a timing diagram illustrating an example of input signals, output signals and node voltages of a write gate signal block of FIG. 17.

FIG. 20 is a circuit diagram illustrating an example of an output control signal block included in a gate emission driver of FIG. 1.

FIG. 21 is a circuit diagram illustrating an example of an initialization gate signal block included in a gate emission driver of FIG. 1.

FIG. 22 is a circuit diagram illustrating an example of a compensation gate signal block included in a gate emission driver of FIG. 1.

FIG. 23 is a circuit diagram illustrating an example of a write gate signal block included in a gate emission driver of FIG. 1.

FIG. 24 is a timing diagram illustrating input signals and output signals of write gate signal block of FIG. 23.

FIG. 25 is a circuit diagram illustrating an example of a write gate signal block included in a gate emission driver of FIG. 1.

FIG. 26 is a diagram illustrating an example of a location of a display panel and a gate emission driver of FIG. 1.

FIG. 27 is a circuit diagram illustrating an example of a pixel included in a display panel of FIG. 1.

FIG. 28 is a circuit diagram illustrating a write gate signal block generating a write gate signal applied to a pixel of FIG. 27.

FIG. 29 is a block diagram illustrating an electronic device according to an embodiment of the present disclosure.

FIG. 30 is a diagram illustrating an example in which the electronic device of FIG. 29 is implemented as a smart phone.

### DETAILED DESCRIPTION OF THE INVENTIVE CONCEPT

Hereinafter, the present inventive concept will be explained in detail with reference to the accompanying drawings.

Embodiments supported by the present disclosure will now be described more fully hereinafter with reference to the accompanying drawings, in which one or more example embodiments are illustrated. Aspects supported by the present disclosure may, however, be embodied in different forms and should not be construed as limited to the embodiments set forth herein. Rather, these example embodiments are provided so that this disclosure will be thorough and complete, and will fully convey the scope of example aspects of the invention to those skilled in the art.

Terms such as, for example, first, second, and the like may be used to describe various components, but the components should not be limited by the terms. The terms as used herein may distinguish one component from other components and are not to be limited by the terms. For example, without departing the scope of the present disclosure, a first component may be referred to as a second component, and similarly, the second component may also be referred to as the first component. The terms of a singular form may include plural forms unless otherwise specified.

The terminology used herein is for the purpose of describing particular embodiments and is not intended to be limiting. As used herein, “a,” “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The terms “about” or “approximately” as used herein are inclusive of the stated value and include a suitable range of deviation for the particular value as determined by one of ordinary skill in the art, considering the measurement in question and the error associated with measurement of the particular quantity. The term “about” can mean within one or more standard deviations, or within +30%, 20%, 10%, 5% of the stated value, for example.

The term “substantially,” as used herein, means approximately or actually. The term “substantially equal” means approximately or actually equal. The term “substantially the same” means approximately or actually the same. The term “substantially identical” means approximately or actually identical. The term “substantially perpendicular” means approximately or actually perpendicular.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Embodiments are described herein with reference to cross section illustrations that are schematic illustrations of example embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases.

It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

It is to be understood that characteristics described herein with respect to relative terms such as, for example, “high,” “low,” and the like refer to the characteristics satisfying (e.g., being greater than, less than, or the like) a threshold associated with the characteristics.

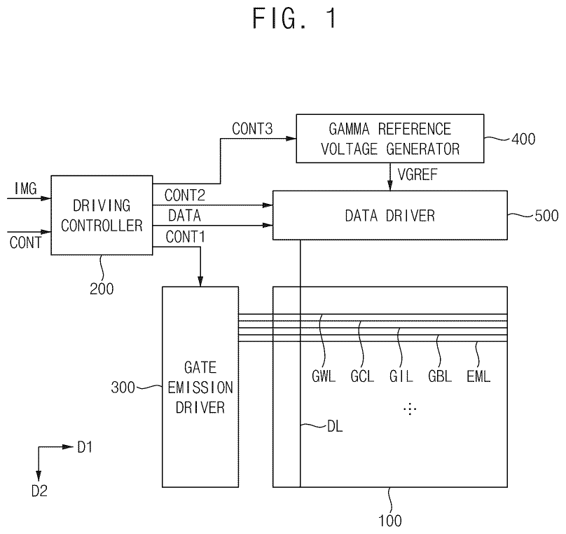

FIG. 1 is a block diagram illustrating a display device according to embodiments of the present disclosure.

Referring to FIG. 1, the display apparatus includes a display panel 100 and a display panel driver. The display panel driver includes a driving controller 200, a gate emission driver 300, a gamma reference voltage generator 400 and a data driver 500.

The display panel 100 has a display region on which an image is displayed and a peripheral region adjacent to the display region.

The display panel 100 includes a plurality of gate lines GWL, GCL, GIL and GBL, a plurality of emission lines EML, a plurality of data lines DL and a plurality of pixels electrically connected to the gate lines GWL, GCL, GIL and GBL, the emission lines EML and the data lines DL. The gate lines GWL, GCL, GIL and GBL may extend in a first direction D1, the emission lines EML may extend in the first direction D1 and the data lines DL may extend in a second direction D2 crossing the first direction D1.

The driving controller 200 receives input image data IMG and an input control signal CONT from an external apparatus. For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, and a data signal DATA based on the input image data IMG and the input control signal CONT.

The driving controller 200 generates the first control signal CONT1 for controlling an operation of the gate emission driver 300 based on the input control signal CONT, and outputs the first control signal CONT1 to the gate emission driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The gate emission driver 300 generates gate signals driving the gate lines GWL, GCL, GIL and GBL in response to the first control signal CONT1 received from the driving controller 200. The gate emission driver 300 may output the gate signals to the gate lines GWL, GCL, GIL and GBL. The gate emission driver 300 generates emission signals driving the emission lines EML in response to the first control signal CONT1 received from the driving controller 200. The gate emission driver 300 may output the emission signals to the emission lines EML.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

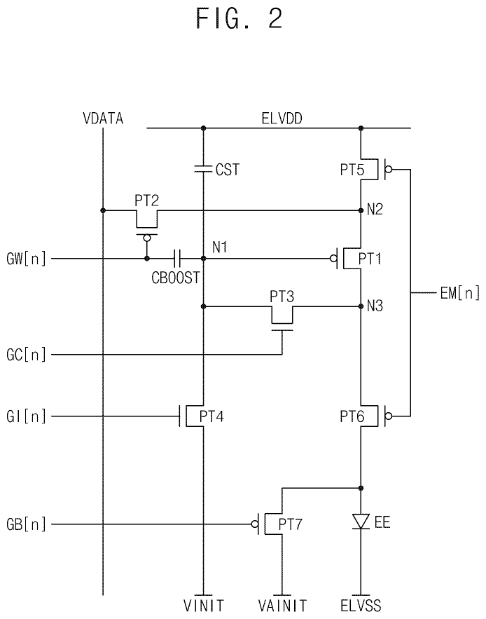

FIG. 2 is a circuit diagram illustrating an example of a pixel of a display panel 100 of FIG. 1.

Referring to FIG. 1 and FIG. 2, the display panel 100 may include a plurality of pixels. Each of the pixels may include a light emitting element EE.

The pixels may receive a write gate signal GW[n], a compensation gate signal GC[n], an initialization gate signal GI[n], a light emitting element initialization gate signal GB[n], an emission signal EM[n] and the data voltage VDATA. The light emitting element EE may emit light based on the data voltage VDATA.

In the present embodiment, the pixel may include a transistor of a first type and a transistor of a second type different from the first type. For example, the transistor of the first type may be a polysilicon thin film transistor. For example, the transistor of the first type may be a low temperature polysilicon (LTPS) thin film transistor. For example, the transistor of the second type may be an oxide thin film transistor. For example, the transistor of the first type may be a P-type transistor and the transistor of the second type may be an N-type transistor. Although some of the transistors of the pixel are the oxide thin film transistors and other transistor of the pixel are the polysilicon thin film transistors in the present embodiment, the present inventive concept may not be limited thereto. The present inventive concept may be applied to cases of a pixel including only oxide thin film transistors. Although some of the transistors of the pixel are the N-type transistors and other transistors of pixel are the P-type transistors in the present embodiment, the present inventive concept may not be limited thereto. The present inventive concept may be applied to cases of a pixel including only the N-type transistors.

At least one of the pixels may include first to seventh pixel transistors PT1 to PT7 and the light emitting element EE.

The first pixel transistor PT1 may include a control electrode connected to a first pixel node N1, a first electrode connected to a second pixel node N2, and a second electrode connected to a third pixel node N3. The second pixel transistor PT2 may include a control electrode receiving the data writing gate signal GW[n], a first electrode receiving the data voltage VDATA, and a second electrode connected to the second pixel node N2. The third pixel transistor PT3 may include a control electrode receiving the compensation gate signal GC[n], a first electrode connected to the first pixel node N1, and a second electrode connected to the third pixel node N3. The fourth pixel transistor PT4 may include a control electrode receiving the data initialization gate signal GI[n], a first electrode receiving an initialization voltage VINIT, and a second electrode connected to the first pixel node N1. The fifth pixel transistor PT5 may include a control electrode receiving the emission signal EM[n], a first electrode receiving a pixel high power voltage ELVDD, and a second electrode connected to the second pixel node N2. The sixth pixel transistor PT6 may include a control electrode receiving the emission signal EM[n], a first electrode connected to the third pixel node N3, and a second electrode connected to an anode electrode of the light emitting element EE. The seventh pixel transistor PT7 may include a control electrode receiving the light emitting element initialization gate signal GB[n], a first electrode receiving a light emitting element initialization voltage VAINIT, and a second electrode connected to the anode electrode of the light emitting element EE. The light emitting element EE may include the anode electrode and a cathode electrode receiving a pixel low power voltage ELVSS.

The pixel may further include a storage capacitor CST including a first electrode receiving the pixel high power voltage ELVDD and a second electrode connected to the first pixel node N1 and a boosting capacitor CBOOST including a first electrode the data writing gate signal GW[n] and a second electrode connected to the first pixel node N1.

A driving current may flow through the fifth pixel transistor PT5, the first pixel transistor PT1 and the sixth pixel transistor PT6 to drive the light emitting element EE. An intensity of the driving current may be determined by the level of the data voltage VDATA. A luminance of the light emitting element EE may be determined by the intensity of the driving current.

In the present embodiment, when the image displayed on the display panel 100 is a static image or the display panel is operated in always on mode, a driving frequency of the display panel 100 may be decreased to reduce a power consumption. In an example in which all of the transistors of the pixel of the display panel 100 are polysilicon thin film transistor, a flicker may be generated due to a leakage current of the pixel transistor in the low frequency driving mode. Thus, some of the pixel transistors may be designed using the oxide thin film transistors.

In the present example embodiment, the third pixel transistor PT3 and the fourth pixel transistor PT4 may be the oxide thin film transistors. The first pixel transistor T1, the second pixel transistor T2, the fifth pixel transistor T5, the sixth pixel transistor T6 and the seventh pixel transistor PT7 may be the polysilicon thin film transistors.

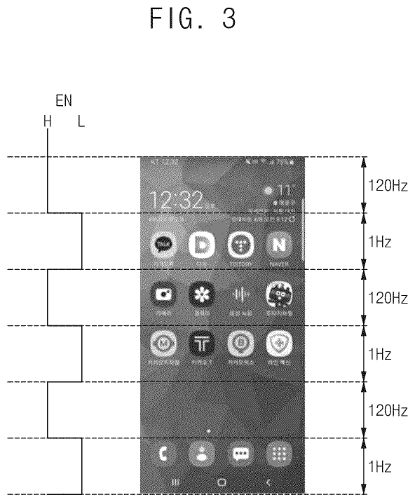

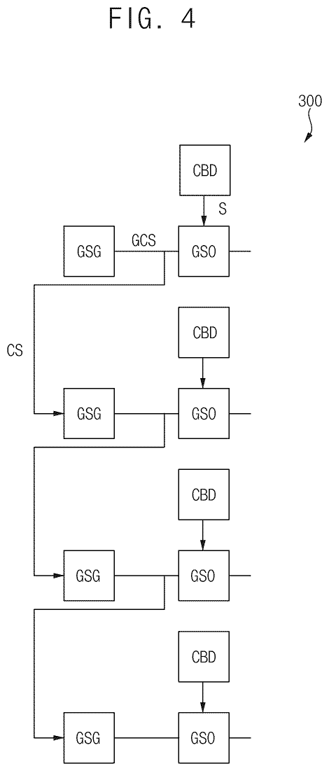

FIG. 3 is a conceptual diagram illustrating an enable signal EN applied to the gate emission driver 300 of FIG. 1 according to driving frequencies of portions of the display panel 100 of FIG. 1. FIG. 4 is a conceptual diagram illustrating the gate emission driver 300 of FIG. 1.

Referring to FIG. 1 to FIG. 4, the gate emission driver 300 may include a gate signal block and an output control signal block CBD. The gate signal block may include a gate signal generator GSG and a gate signal outputter GSO. Example aspects of the gate signal block are also described with reference to gate signal block GID described herein. The term “signal outputter” used herein may refer to a block or electronic circuit capable of providing or generating a signal.

The gate signal generator GSG may generate a carry signal CS and a gate control signal GCS based on a previous carry signal. The gate signal outputter GSO may output the gate signal based on the previous carry signal. In an embodiment, the gate signal outputter GSO may output the gate signal based on the gate control signal GCS. In the present embodiment, the gate signal outputter GSO may output the gate signal in response to the output control signal S. The output control signal block CBD may generate the output control signal S based on the emission signal EM[n] and the enable signal EN. The output control signal block CBD may output the output control signal S to the gate signal outputter GSO. For example, the gate signal generator GSG may be called as a first driver. For example, the gate signal outputter GSO may be called as a second driver.

The gate signal outputter GSO may output or not output a gate pulse based on the enable signal EN.

In an example in which the enable signal EN has a high level H, the gate signal outputter may output the gate pulse. In an example in which the enable signal EN has the high level H, the gate signal may have an activation level.

In an example in which the enable signal EN has a low level L, the gate signal outputter GSO may not output the gate pulse. In an example in which the enable signal EN has the low level L, the gate signal may have an inactivation level.

The gate emission driver 300 may output the gate pulse at a high frequency (e.g., 120 Hz) for a portion of the display panel 100 where a high frequency driving is desired, and the gate emission driver 300 may output a gate pulse at a low frequency (e.g., 1 Hz) for a portion of the display panel 100 where a low frequency driving is desired according to the enable signal EN.

The output control signal block CBD may output the gate pulse in the low frequency (e.g., 1 Hz) by masking an output of the gate pulse. For example, the output control signal block CBD may mask the output of the gate pulse by outputting the output control signal S to the gate signal outputter GSO. Descriptions herein of masking an output of the gate pulse as described herein include masking the gate pulse or masking portions of the gate pulse.

The gate signal generator transfers the carry signal CS to a next stage regardless of the operation of the output control signal block CBD masking the output of the gate pulse, such that the gate emission driver 300 may support the multiple division of the driving frequency. That is, for example, the techniques described herein support driving different portions of the display panel 100 according to different respective driving frequencies (e.g., high frequency, low frequency, or the like).

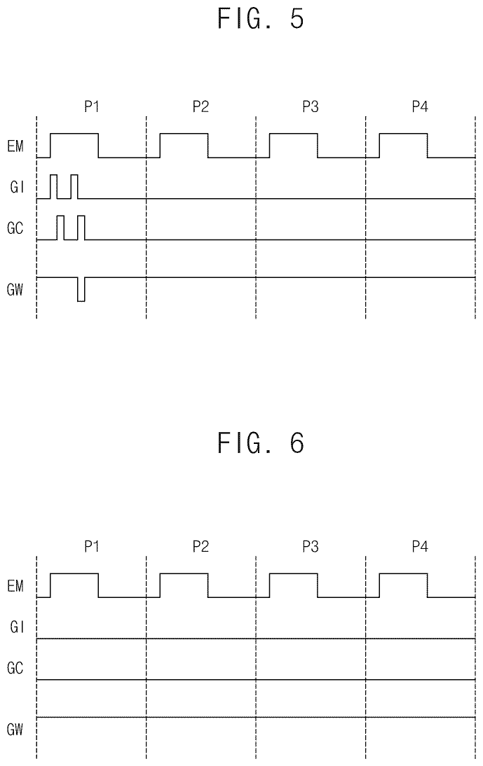

FIG. 5 is a timing diagram illustrating input signals applied to the pixel of FIG. 2 in a data writing period. FIG. 6 is a timing diagram illustrating input signals applied to the pixel of FIG. 2 in a self-scan period.

Referring to FIGS. 1 to 6, in a low frequency driving mode, a driving timing of the display panel 100 includes a data writing period in which the data voltage is written to the pixel and the pixel emits a light and a self-scan period in which the data voltage is not written to the pixel and the pixel emits a light.

In a first frame P1 of FIG. 5 which is the data writing period, the data initialization gate signal GI, the compensation gate signal GC and the data writing gate signal GW may have active pulses. Second to fourth frames P2 to P4 of FIG. 5 may be the self scan periods.

As illustrated in the first frame P1 of FIG. 5, the data initialization gate signal GI may output a single pulse in the frame. As illustrated in the first frame P1 of FIG. 5, the compensation gate signal GC may output two pulses in the frame.

In contrast, in a first frame P1 of FIG. 6 which is the self scan period, the data initialization gate signal GI, the compensation gate signal GC and the data writing gate signal GW may not have any active pulses. Second to fourth frames P2 to P4 of FIG. 6 may be the self scan periods.

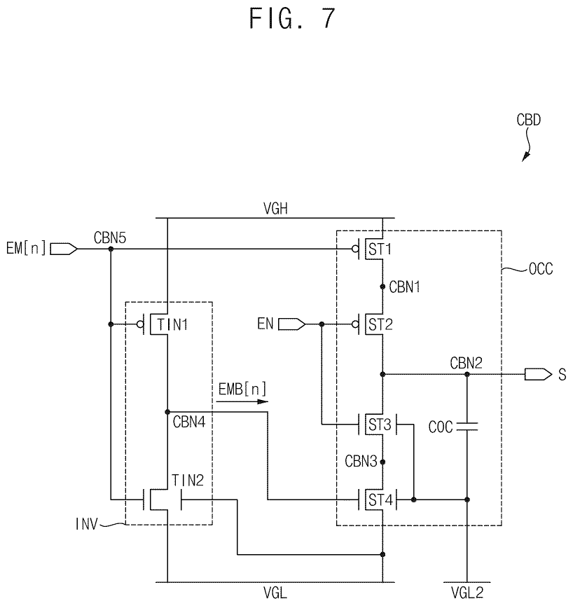

FIG. 7 is a circuit diagram illustrating an example of an output control signal block CBD included in a gate emission driver 300 of FIG. 1.

In the present embodiment, the output control signal block CBD may include an inverter circuit INV and an output determining circuit OCC. The inverter circuit INV may receive the emission signal EM[n]. the inverter circuit INV may convert the emission signal EM[n] to the inverted emission signal EMB[n]. The output determining circuit OCC may generate the output control signal S based on the enable signal EN, the emission signal EM[n], the inverted emission signal EMB[n]. For example, the output control signal block CBD may be called as an output control circuit.

The inverter circuit INV may include a first inverter transistor TIN1 and a second inverter transistor TIN2.

The first inverter transistor TIN1 may include a control electrode receiving the emission signal EM[n], a first electrode receiving a first power voltage VGH, and a second electrode connected to a fourth control node CBN4. For example, the control electrode of the first inverter transistor TIN1 may be connected to a fifth control node CBN5. In an embodiment, the first inverter transistor TIN1 may be a P-type transistor.

The second inverter transistor TIN2 may include a control electrode receiving the emission signal EM[n], a first electrode connected to the fourth control node CBN4, and a second electrode receiving a second power voltage VGL. The second power voltage VGL may be lower than the first power voltage VGH. For example, the control electrode of the second inverter transistor TIN2 may be connected to the fifth control node CBN5. In an embodiment, the second inverter transistor TIN2 may be an N-type transistor. In an embodiment, the second inverter transistor TIN2 may further include a second control electrode receiving a third power voltage VGL2.

The output determining circuit OCC may include a first determining transistor ST1, a second determining transistor ST2, a third determining transistor ST3 and a fourth determining transistor ST4.

The first determining transistor ST1 may include a control electrode receiving the emission signal EM[n], a first electrode receiving the first power voltage VGH, and a second electrode connected to a first control node CBN1. In an embodiment, the control electrode of the first determining transistor ST1 may be connected to the fifth control node CBN5. In an embodiment, the first determining transistor ST1 may be a P-type transistor.

The second determining transistor ST2 may include a control electrode receiving the enable signal EN, a first electrode connected to the first control node, CBN1 and a second electrode connected to a second control node CBN2. In an embodiment, the second determining transistor ST2 may be a P-type transistor.

The third determining transistor ST3 may include a control electrode receiving the enable signal EN, a first electrode connected to the second control node CBN2, and a second electrode connected to a third control node CBN3. In an embodiment, the third determining transistor ST3 may be an N-type transistor. In an embodiment, the third determining transistor ST3 may further include a second control electrode receiving the third power voltage VGL2. Accordingly, an output stability of the output control signal S may be improved.

The fourth determining transistor ST4 may include a control electrode receiving the inverted emission signal EMB[n], a first electrode connected to the third control node CBN3, and a second electrode receiving the second power voltage VGL. In an embodiment, the fourth determining transistor ST4 may be an N-type transistor. In an embodiment, the fourth determining transistor ST4 may further include a second control electrode receiving the third power voltage VGL2. In an embodiment, the second determining transistor ST2 may be a P-type transistor.

In an embodiment, the output control signal block CBD may further include a control capacitor COC.

The control capacitor COC may include a first electrode receiving the third power voltage VGL2 and a second electrode connected to the second control node CBN2. The second power voltage VGL and the third power voltage VGL2 may be different. Accordingly, an output stability of the output control signal S may be improved.

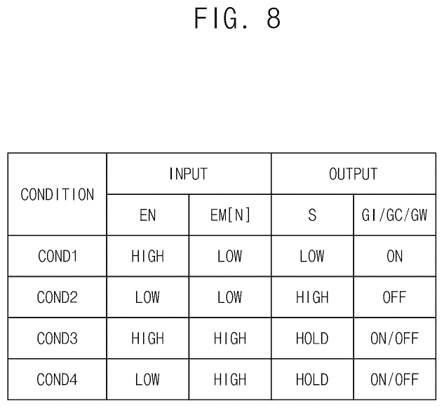

FIG. 8 is a table illustrating a status of an output signal according to an input signal of an output control signal block CBD of FIG. 7.

Referring to FIG. 7 to FIG. 8, when the enable signal EN has a high level and the emission signal EM[n] has a low level, the output control signal S may have a low level. This condition may be defined as a first condition COND1.

When the enable signal EN has a low level and the emission signal EM[n] has a low level, the output control signal S may have a high level. This condition may be defined as a second condition COND2.

When the enable signal EN has a high level and the emission signal EM[n] has a high level, the output control signal S may maintain a previous status. This condition may be defined as a third condition COND3.

When the enable signal EN has a low level and the emission signal EM[n] has a high level, the output control signal S may maintain a previous status. This condition may be defined as a fourth condition COND4.

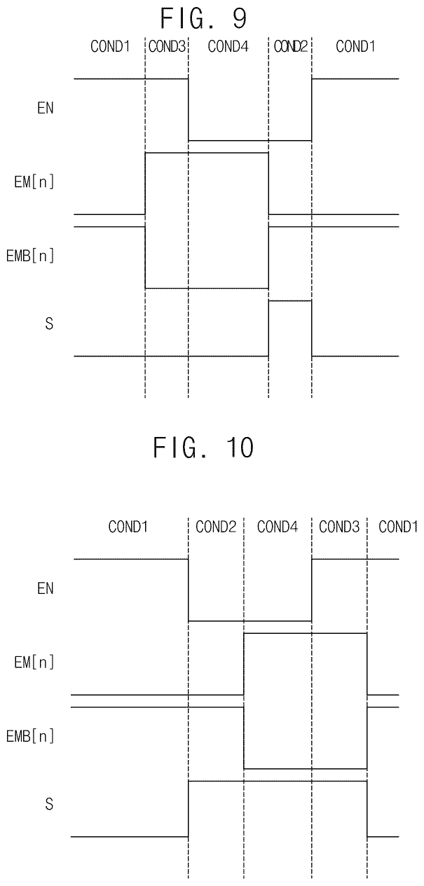

FIG. 9 is a timing diagram illustrating input signals and an output signal of an output control signal block CBD of FIG. 7 when a period when the emission signal EM[n] maintains a high level is included in a high period of the enable signal EN.

Referring to FIG. 4 and FIG. 7 to FIG. 9, FIG. 9 represents a case in which a period when the emission signal EM[n] maintains a high level is included in a high period of the enable signal EN. In this case, the gate signal may be normally outputted.

In a first period, the enable signal EN has the high level and the signal EM[n] has the low level such that the first condition COND1 is satisfied. Accordingly, the output control signal S may have the low level. Accordingly, the gate signal may be outputted.

In a second period, the enable signal EN has the high level and the signal EM[n] has the high level such that the third condition COND3 is satisfied. Accordingly, the output control signal S may maintain a previous status. For example, the output control signal S may have the low level. Accordingly, the gate signal may be outputted.

In a third period, the enable signal EN has the low level and the signal EM[n] has the high level such that the fourth condition COND4 is satisfied. Accordingly, the output control signal S may maintain a previous status. For example, the output control signal S may have the low level. Accordingly, the gate signal may be outputted.

In a fourth period, the enable signal EN has the low level and the signal EM[n] has the low level such that the second condition COND2 is satisfied. Accordingly, the output control signal S may have the high level.

In a fifth period, the enable signal EN has the high level and the signal EM[n] has the low level such that the first condition COND1 is satisfied. Accordingly, the output control signal S may have the low level.

FIG. 10 is a timing diagram illustrating input signals and an output signal of an output control signal block CBD of FIG. 7 when a period when the emission signal EM[n] changes from a high level to a low level is included in a low period of the enable signal EN.

Referring to FIG. 4, FIG. 7, FIG. 9 and FIG. 10, in a first period, the enable signal EN has the high level and the signal EM[n] has the high level such that the third condition COND3 is satisfied. Accordingly, the output control signal S may maintain a previous status. For example, the output control signal S may have the low level. Accordingly, the gate signal may be outputted.

In a second period, the enable signal EN has the low level and the signal EM[n] has the low level such that the second condition COND2 is satisfied. Accordingly, the output control signal S may have the high level. Accordingly, the gate signal may not be outputted.

In a third period, the enable signal EN has the low level and the signal EM[n] has the high level such that the fourth condition COND4 is satisfied. Accordingly, the output control signal S may maintain a previous status. For example, the output control signal S may have the high level. Accordingly, the gate signal may not be outputted.

In a fourth period, the enable signal EN has the high level and the signal EM[n] has the high level such that the third condition COND3 is satisfied. Accordingly, the output control signal S may maintain a previous status. For example, the output control signal S may have the high level. Accordingly, the gate signal may not be outputted.

In a fifth period, the enable signal EN has the high level and the signal EM[n] has the low level such that the first condition COND1 is satisfied. Accordingly, the output control signal S may have the low level.

In the present embodiment, an output of the gate signal may be controlled based on the enable signal EN and the emission signal EM[n]. Accordingly, the multiple division of the driving frequency may be supported.

In some aspects, the output control signal block CBD may generate the output control signal based on the enable signal EN and the emission signal EM[n]. Accordingly, the output control signal block CBD may be located on a first side and a second side different from the first side of the display panel 100.

In some aspects, through the multiple division of the driving frequency, the power consumption of the display apparatus may be effectively reduced. Addition, the multiple division of the driving frequency of the gate signal having two or more pulses may be supported.

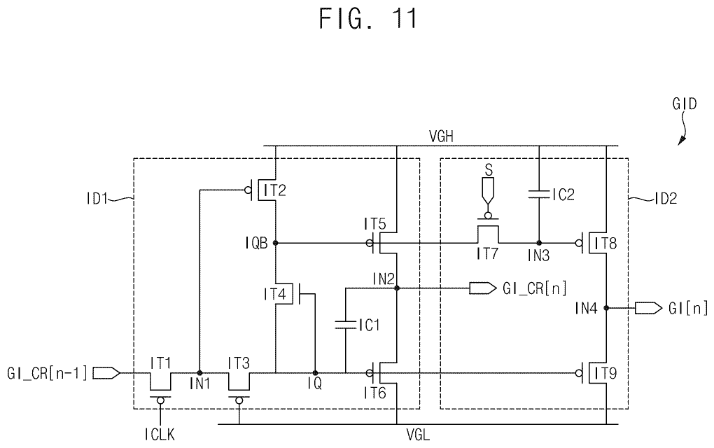

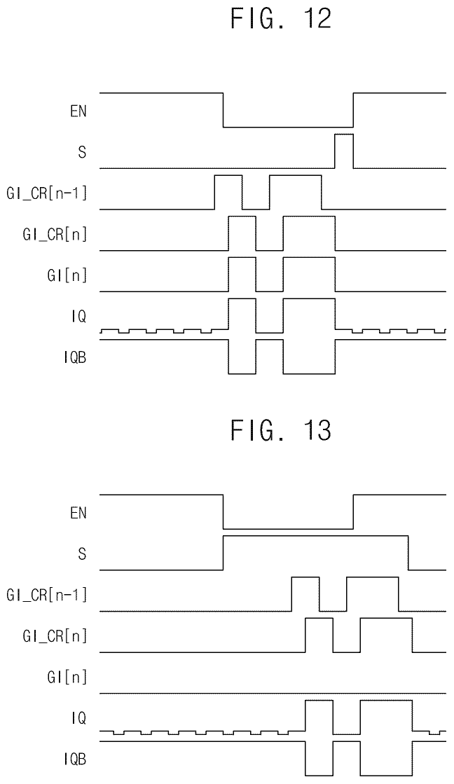

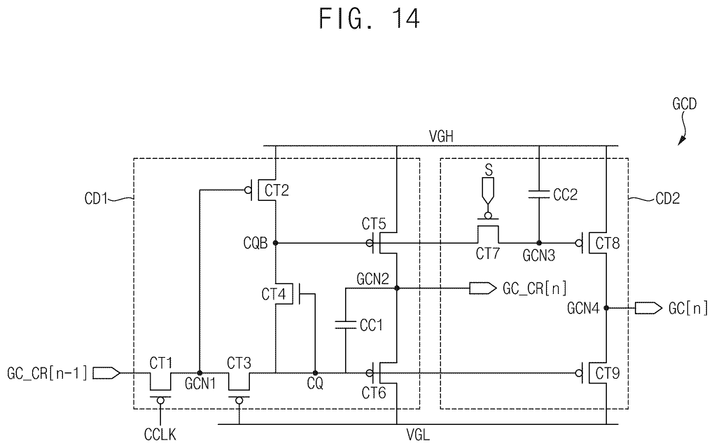

FIG. 11 is a circuit diagram illustrating an example of an initialization gate signal block GID included in a gate emission driver 300 of FIG. 1. FIG. 12 is a timing diagram illustrating an example of input signals, output signals and node voltages of an initialization gate signal block GID of FIG. 11. FIG. 13 is a timing diagram illustrating an example of input signals, output signals and node voltages of an initialization gate signal block GID of FIG. 11.

Referring to FIG. 1 to FIG. 13, in the present embodiment, the gate signal block may be an initialization gate signal block GID. The initialization gate signal block GID may output the initialization gate signal GI[n]. The initialization gate signal block GID may include a first driver ID1 and a second driver ID2.

The first driver ID1 may include first to sixth initialization transistors IT1 to IT2 and a first initialization capacitor IC1.

The first initialization transistor IT1 may include a control electrode receiving an initialization clock signal ICLK, a first electrode receiving a previous initialization carry signal GI_CR[n−1], and a second electrode connected to a first initialization node IN1. The second initialization transistor IT2 may include a control electrode connected to the first initialization node IN1, a first electrode receiving the first power voltage VGH, and a second electrode connected to a second initialization control node IQB. The third initialization transistor IT3 may include a control electrode receiving the second power voltage VGL, a first electrode connected to the first initialization node IN1, and a second electrode connected to a first initialization control node IQ. The fourth initialization transistor IT4 may include a control electrode connected to the first initialization control node IQ, a first electrode receiving the second power voltage VGL, and a second electrode connected to the second initialization control node IQB. The fifth initialization transistor IT5 may include a control electrode connected to the second initialization control node IQB, a first electrode receiving the first power voltage VGH, and a second electrode connected to a second initialization node IN2. The sixth initialization transistor IT6 may include a control electrode connected to the first initialization control node IQ, a first electrode receiving the second power voltage VGL, and a second electrode connected to the second initialization node IN2.

For example, a voltage of the first initialization control node IQ may be called as an initialization gate control signal. A signal of second initialization node IN2 may be an initialization carry signal GI_CR[n]. The fifth initialization transistor IT5 may be called as a first initialization carry transistor. The sixth initialization transistor IT6 may be called as a second initialization carry transistor.

The second driver ID2 may include seventh to ninth initialization transistors IT7 to IT9.

The seventh initialization transistor IT7 may include a control electrode receiving the output control signal S, a first electrode connected to the second initialization control node IQB, and a second electrode connected to a third initialization node IN3. The eighth initialization transistor IT8 may include a control electrode connected to the third initialization node IN3, a first electrode receiving the first power voltage VGH, and a second electrode connected to a fourth initialization node IN4. The ninth initialization transistor IT9 may include a control electrode connected to the first initialization control node IQ, a first electrode connected to the fourth initialization node IN4 and the second electrode receiving the second power voltage VGL.

For example, a signal of the fourth initialization node IN4 may be the initialization gate signal GI[n]. The seventh initialization transistor IT7 may be called as a first initialization output transistor. The eighth initialization transistor IT8 may be called as a second initialization output transistor. The ninth initialization transistor IT9 may be called as a third initialization output transistor.

In the present embodiment, as illustrated in FIG. 12, when the output control signal S has an activation level (e.g., low level), the initialization gate signal GI[n] may be outputted. In an example in which the output control signal has the activation level, the second driver ID2 may output a gate pulse. In some aspects, the initialization carry signal GI_CR[n] may be outputted.

As illustrated in FIG. 13, when the output control signal S has an inactivation level (e.g., high level), the initialization gate signal GI[n] may not be outputted. In an example in which the output control signal S has the inactivation level, the second driver ID2 may not output a gate pulse. In an example in which the output control signal S has the activation level, the initialization carry signal GI_CR[n] may be outputted.

In the present embodiment, the initialization gate signal block GID may output the initialization carry signal GI_CR[n] and the initialization gate signal GI[n]. Accordingly, when the output control signal S has the activation level (e.g., the low level), the initialization gate signal GI[n] may have an inactivation level and the initialization carry signal GI_CR[n] may have an activation level. Accordingly, the gate emission driver 300 may support the multiple division of the driving frequency. In some aspects, through the multiple division of the driving frequency, the power consumption of the display apparatus may be effectively reduced. In some aspects, the multiple division of the driving frequency of the initialization gate signal GI[n] having two or more pulses may be supported.

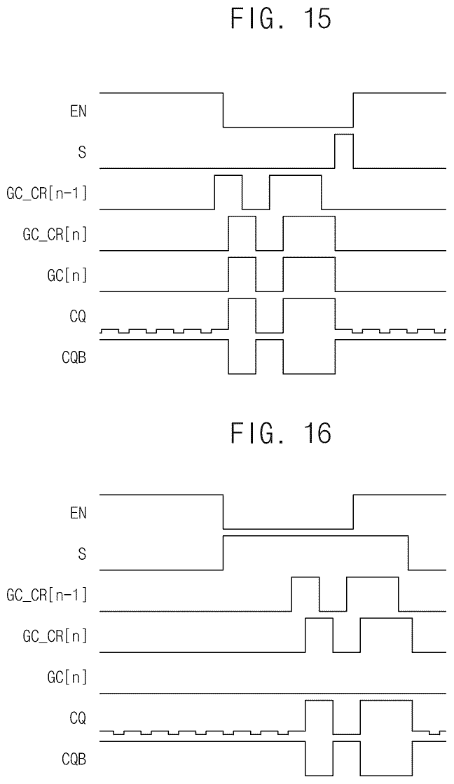

FIG. 14 is a circuit diagram illustrating an example of a compensation gate signal block GCD included in a gate emission driver 300 of FIG. 1. FIG. 15 is a timing diagram illustrating an example of input signals, output signals and node voltages of a compensation gate signal block GCD of FIG. 14. FIG. 16 is a timing diagram illustrating an example of input signals, output signals and node voltages of a compensation gate signal block GCD of FIG. 14.

Referring to FIG. 1 to FIG. 10 and FIG. 14 to FIG. 16, in the present embodiment, the gate signal block may be a compensation gate signal block GCD. The compensation gate signal block GCD may output the compensation gate signal GC[n]. The compensation gate signal block GCD may include a first driver CD1 and a second driver CD2.

The first driver CD1 may include first to sixth compensation transistors CT1 to CT6 and a first compensation capacitor CC1.

The first compensation transistor CT1 may include a control electrode receiving a compensation clock signal CCLK, a first electrode receiving a previous compensation carry signal GC_CR[n−1], and a second electrode connected to a first compensation node GCN1. The second compensation transistor CT2 may include a control electrode connected to the first compensation node GCN1, a first electrode receiving the first power voltage VGH, and a second electrode connected to a second compensation control node GCQB. The third compensation transistor CT3 may include a control electrode receiving the second power voltage VGL, a first electrode connected to the first compensation node GCN1, and a second electrode connected to a first compensation control node GCQ. The fourth compensation transistor CT4 may include a control electrode connected to the first compensation control node GCQ, a first electrode receiving the second power voltage VGL, and a second electrode connected to the second compensation control node GCQB. The fifth compensation transistor CT5 may include a control electrode connected to the second compensation control node GCQB, a first electrode receiving the first power voltage VGH, and a second electrode connected to a second compensation node GCN2. The sixth compensation transistor CT6 may include a control electrode connected to the first compensation control node GCQ, a first electrode receiving the second power voltage VGL, and a second electrode connected to the second compensation node GCN2.

For example, a voltage of the first compensation control node GCQ may be called as a compensation gate control signal. A signal of second compensation node GCN2 may be a compensation carry signal GC_CR[n]. The fifth compensation transistor CT5 may be called as a first compensation carry transistor. The sixth initialization transistor CT6 may be called as a second compensation carry transistor.

The second driver CD2 may include seventh to ninth compensation transistors CT7 to CT9.

The seventh compensation transistor CT7 may include a control electrode receiving the output control signal S, a first electrode connected to the second compensation control node GCQB, and a second electrode connected to a third compensation node GCN3. The eighth compensation transistor CT8 may include a control electrode connected to the third compensation node GCN3, a first electrode receiving the first power voltage VGH, and a second electrode connected to a fourth compensation node GCN4. The ninth compensation transistor CT9 may include a control electrode connected to the first compensation control node GCQ, a first electrode connected to the fourth compensation node GCN4 and the second electrode receiving the second power voltage VGL.

For example, a signal of the fourth compensation node GCN4 may be the compensation gate signal GC[n]. The seventh compensation transistor CT7 may be called as a first compensation output transistor. The eighth compensation transistor CT8 may be called as a second compensation output transistor. The ninth compensation transistor CT9 may be called as a third compensation output transistor.

In the present embodiment, as illustrated in FIG. 15, when the output control signal S has the activation level, the compensation gate signal GC[n] may be outputted. In an example in which the output control signal has the activation level, the second driver CD2 may output a gate pulse. In some aspects, the compensation carry signal GC_CR[n] may be outputted.

As illustrated in FIG. 16, when the output control signal S has the inactivation level, the compensation gate signal GC[n] may not be outputted. In an example in which the output control signal S has the inactivation level, the second driver CD2 may not output a gate pulse. In an example in which the output control signal S has the activation level, the compensation carry signal GC_CR[n] may be outputted.

In the present embodiment, the compensation gate signal block GCD may output the compensation carry signal GC_CR[n] and the compensation gate signal GC[n]. Accordingly, when the output control signal S has the activation level (e.g., the low level), the compensation gate signal GC[n] may have an inactivation level and the compensation carry signal GC_CR[n] may have an activation level. Accordingly, the gate emission driver 300 may support the multiple division of the driving frequency. In some aspects, through the multiple division of the driving frequency, the power consumption of the display apparatus may be effectively reduced. In some aspects, the multiple division of the driving frequency of the compensation gate signal GC[n] having two or more pulses may be supported.

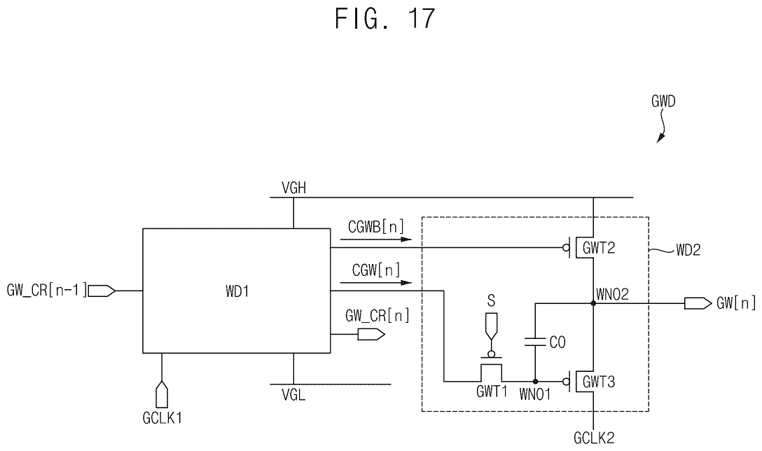

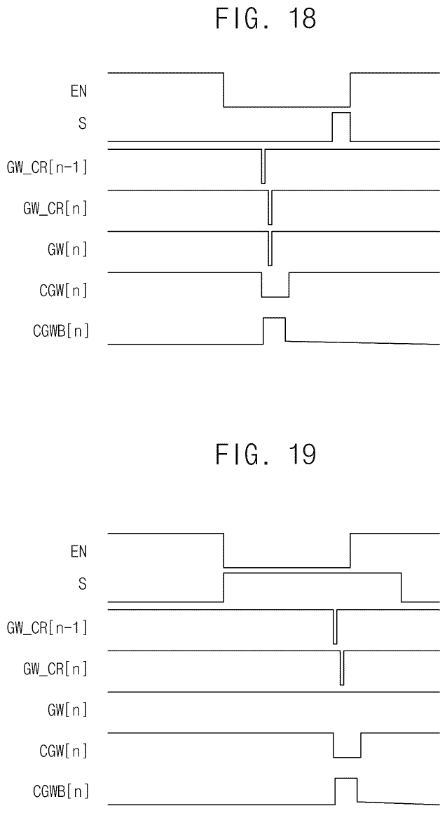

FIG. 17 is a circuit diagram illustrating an example of a write gate signal block GWD included in a gate emission driver 300 of FIG. 1. FIG. 18 is a timing diagram illustrating an example of input signals, output signals and node voltages of a write gate signal block GWD of FIG. 17. FIG. 19 is a timing diagram illustrating an example of input signals, output signals and node voltages of a write gate signal block GWD of FIG. 17.

Referring to FIG. 1 to FIG. 10 and FIG. 17 to FIG. 19, in the present embodiment, the gate signal block may be a write gate signal block GWD. The write gate signal block GWD may output the write gate signal GW[n]. The write gate signal block GWD may include a first driver WD1 and a second driver WD2.

The first driver WD1 may generate a write gate control signal based on a previous write carry signal GW_CR[n−1] and a first clock signal GCLK1. The write gate control signal may include a first write gate control signal CGW[n] and a second write gate control signal CGWB [n]. For example, the second write gate control signal CGWB [n] may be an inverted signal of the first write gate control signal CGW[n].

The second driver CD2 may include first to third write transistors GWT1 to GWT3. The first write transistor GWT1 may include a control electrode receiving the output control signal S, a first electrode receiving the first write gate control signal CGW[n], and a second electrode connected to a first write output node WNO1. The second write transistor GWT2 may include a control electrode receiving the second write gate control signal CGWB [n], a first electrode receiving the first power voltage VGH, and a second electrode connected to a second write output node WNO2. The third write transistor GWT3 may include a control electrode connected to the first write output node WNO1, a first electrode connected to the second write output node WNO2 and the second electrode receiving a second clock signal GCLK2 different from the first clock signal GCLK1. A signal of the second write output node WNO2 may be the write gate signal GW[n].

In the present embodiment, as illustrated in FIG. 18, when the output control signal S has the activation level, the write gate signal GW[n] may be outputted. In an example in which the output control signal has the activation level, the second driver WD2 may output a gate pulse. In some aspects, the write carry signal GW_CR[n] may be outputted.

As illustrated in FIG. 19, when the output control signal S has the inactivation level, the write gate signal GW[n] may not be outputted. In an example in which the output control signal S has the inactivation level, the second driver WD2 may not output a gate pulse. In an example in which the output control signal S has the activation level, the write carry signal GW_CR[n] may be outputted.

In the present embodiment, the write gate signal block GWD may output the write carry signal GW_CR[n] and the write gate signal GW[n]. Accordingly, when the output control signal S has the activation level (e.g., the low level), the write gate signal GW[n] may have an inactivation level and the write carry signal GW_CR[n] may have an activation level. Accordingly, the gate emission driver 300 may support the multiple division of the driving frequency. In some aspects, through the multiple division of the driving frequency, the power consumption of the display apparatus may be effectively reduced.

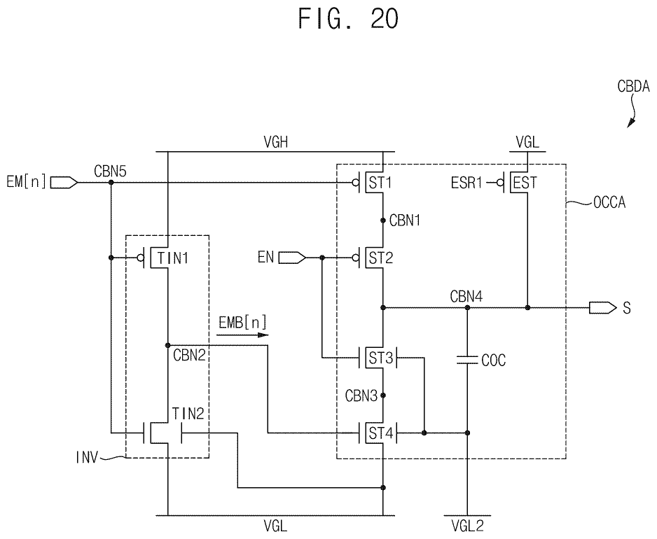

FIG. 20 is a circuit diagram illustrating an example of an output control signal block included in a gate emission driver 300 of FIG. 1.

An output control signal block CBDA according to the present embodiment is substantially the same as the output control signal block CBD of FIG. 7, except that the output control signal block CBDA further includes an output power transistor EST. Accordingly, the same reference numerals will be used to refer to the same and any repetitive explanation concerning the above elements will be omitted.

Referring to FIG. 7 and FIG. 20, in the present embodiment, the output control signal block CBDA may include an output power transistor EST. The output power transistor EST may include a control electrode receiving a first power signal ESR1, a first electrode receiving the second power voltage VGL, and a second electrode connected to the fourth control node CBN4. The output power transistor EST may apply the second power voltage VGL to the fourth control node CBN4 in response to the first power signal ESR1. Accordingly, the fourth control node CBN4 may be initialized. Accordingly, an output stability of the output control signal S may be further improved.

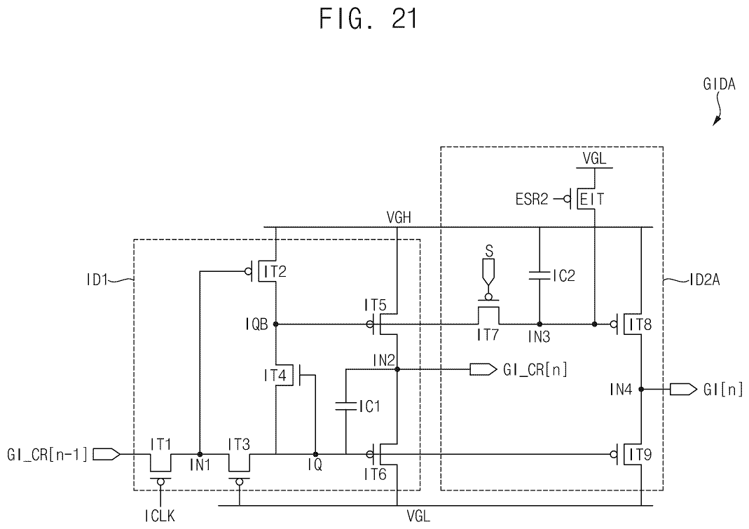

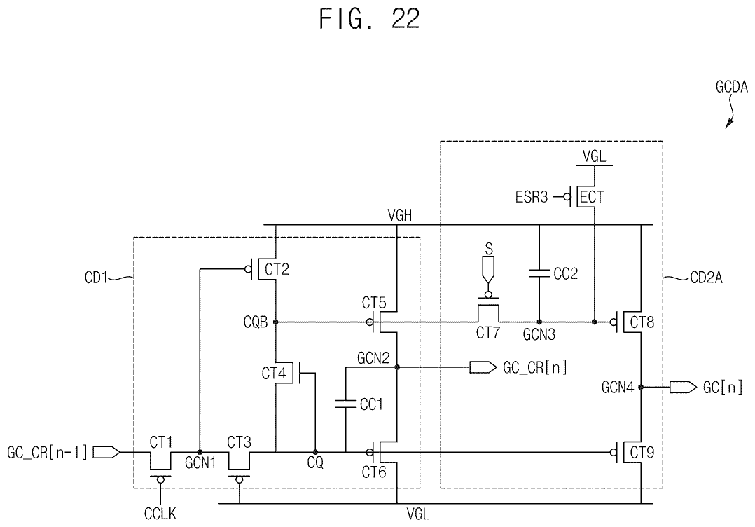

FIG. 21 is a circuit diagram illustrating an example of an initialization gate signal block included in a gate emission driver 300 of FIG. 1.

An initialization gate signal block GIDA according to the present embodiment is substantially the same as the initialization gate signal block GID of FIG. 11, except that the initialization gate signal block GIDA further includes an initialization power transistor EIT. Accordingly, the same reference numerals will be used to refer to the same and any repetitive explanation concerning the above elements will be omitted.

Referring to FIG. 11 and FIG. 21, in the present embodiment, the initialization gate signal block GIDA may include a first driver ID1 and a second driver ID2A. The second driver ID2A may include the initialization power transistor EIT. The initialization power transistor EIT may include a control electrode receiving a second power signal ESR2, a first electrode receiving the second power voltage VGL2, and a second electrode connected to the third initialization node IN3. The initialization power transistor EIT may apply the second power voltage VGL to the third initialization node IN3 in response to the second power signal ESR2. Accordingly, the third initialization node IN3 may be initialized. Accordingly, an output stability of the initialization gate signal GI[n] may be further improved.

FIG. 22 is a circuit diagram illustrating an example of a compensation gate signal block included in a gate emission driver 300 of FIG. 1.

A compensation gate signal block GCDA according to the present embodiment is substantially the same as the compensation gate signal block GCD of FIG. 14, except that the compensation gate signal block GCDA further includes a compensation power transistor ECT. Accordingly, the same reference numerals will be used to refer to the same and any repetitive explanation concerning the above elements will be omitted.

Referring to FIG. 14 and FIG. 22, in the present embodiment, the compensation gate signal block GCDA may include the compensation power transistor ECT. The compensation power transistor ECT may include a control electrode receiving a third power signal ESR3, a first electrode receiving the second power voltage VGL2, and a second electrode connected to the third compensation node GCN3. The compensation power transistor ECT may apply the second power voltage VGL to the third compensation node GCN3 in response to the third power signal ESR3. Accordingly, the third compensation node GCN3 may be initialized. Accordingly, an output stability of the compensation gate signal GC[n] may be further improved.

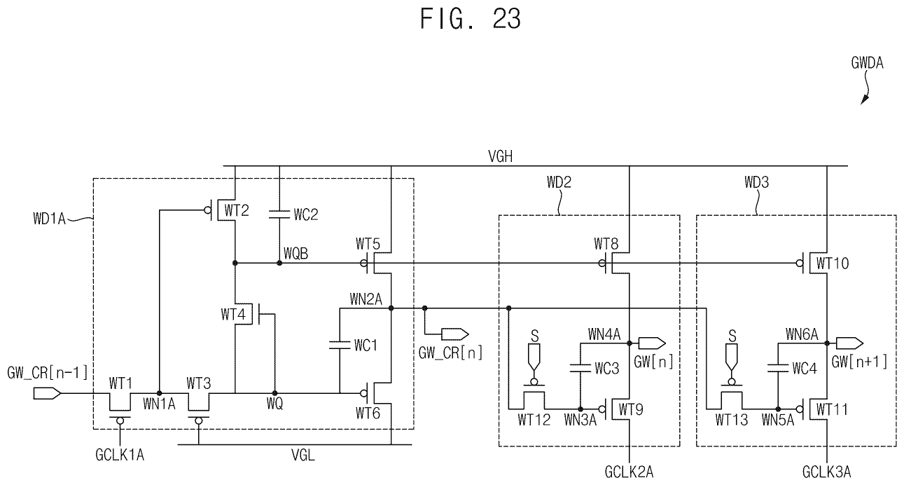

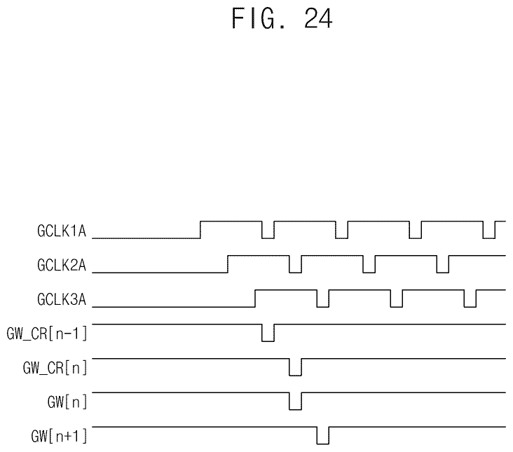

FIG. 23 is a circuit diagram illustrating an example of a write gate signal block included in a gate emission driver 300 of FIG. 1. FIG. 24 is a timing diagram illustrating input signals and output signals of write gate signal block GWDA of FIG. 23.

Referring to FIG. 23, a write gate signal block GWDA may include a first driver WD1A, the second driver WD2 and a third driver WD3. The second driver WD2 may be called as a write gate signal outputter. The third driver WD3 may be called as next write gate signal outputter.

The first driver WD1A may include first to six transistors WT1 to WT6, a first write capacitor WC1 and a second write capacitor WC2. The first write transistor WT1 may include a control electrode receiving a first clock signal GCLK1A, a first electrode receiving the previous write carry signal GW_CR[n−1], and a second electrode connected to a first write node WN1A. The second write transistor WT2 may include a control electrode connected to the first write node WN1A, a first electrode receiving the first power voltage VGH, and a second electrode connected to a second write control node WQB. The third write transistor WT3 may include a control electrode receiving the second power voltage VGL, a first electrode connected to the first write node WN1A, and a second electrode connected to a first write control node WQ. The fourth write transistor WT4 may include a control electrode connected to the first write control node WQ, a first electrode receiving the second power voltage VGL, and a second electrode connected to the second write control node WQB. The fifth write transistor WT5 may include a control electrode connected to the second write control node WQB, a first electrode receiving the first power voltage VGH, and a second electrode connected to a second write node WN2A. The sixth write transistor WT6 may include a control electrode connected to the first write control node WQ, a first electrode receiving the second power voltage VGL, and a second electrode connected to the second write node WN2A. The first write capacitor WC1 may include a first electrode connected to the first write control node WQ and a second electrode connected to the second write node WN2A. The second write capacitor WC2 may include a first electrode connected to the second write control node WQB and a second electrode receiving the first power voltage VGH. A signal of the second write node WN2A may be the write carry signal GW_CR[n].

The second driver WD2 may include an eighth write transistor WT8, a ninth write transistor WT9, a twelfth write transistor WT12 and a third write capacitor WC3. The eighth write transistor WT9 may include a control electrode connected to the second write control node WQB, a first electrode receiving the first power voltage VGH, and a second electrode connected to a fourth write node WN4A. The ninth write transistor WT9 may include a control electrode connected to a third write node WN3A, a first electrode receiving a second clock signal GCLK2A, and a second electrode connected to the fourth write node WN4A. The twelfth write transistor WT12 may include a control electrode receiving the output control signal S, a first electrode connected to the second write node WN2A, and a second electrode connected to the third write node WN3A. The third write capacitor WC3A may include a first electrode connected to the third write node WN3A and a second electrode connected to the fourth write node WN4A. For example, the third write node WN3A may be corresponding to the first write output node WNO1 of FIG. 17. The fourth write node WN4A may be corresponding to the second write output node WNO2 of FIG. 17. A signal of the fourth write node WN4A may be the write gate signal GW[n].

The third driver WD3 may include a tenth write transistor WT10, an eleventh write transistor WT11, a thirteenth write transistor WT13 and a fourth write capacitor WC4. The tenth write transistor WT10 may include a control electrode connected to the second write control node WQB, a first electrode receiving the first power voltage VGH, and a second electrode connected to a sixth write node WN6A. The tenth write transistor WT10 may be called as a fifth write output transistor. The eleventh write transistor WT11 may include a control electrode connected to a fifth write node WN5A, a first electrode receiving a third clock signal GCLK3A, and a second electrode connected to the sixth write node WN6A. The eleventh write transistor WT11 may be called as a sixth write output transistor. The thirteenth write transistor WT13 may include a control electrode receiving the output control signal S, a first electrode connected to the second write node WN2A, and a second electrode connected to a fifth write node WN5A. The thirteenth write transistor WT13 may be called as a fourth write output transistor. The fourth write capacitor WC4 may include a first electrode connected to the fifth write node WN5A and a second electrode connected to the sixth write node WN6A. For example, the fifth write node WN5A may be called as the third write output node. For example, the sixth write node WN6A may be called as the fourth write output node. A signal of the sixth write node WN6A may be a next write gate signal GW[n+1].

In the present embodiment, the write gate signal block GWDA may output the write carry signal GW_CR[n] and the write gate signal GW[n]. Accordingly, when the output control signal S has an activation level (e.g., a low level), the write gate signal GW[n] may have an inactivation level and the write carry signal GW_CR[n] may have an activation level. Accordingly, the multiple division of the driving frequency may be support. In some aspects, through the multiple division of the driving frequency, the power consumption of the display apparatus may be effectively reduced.

In some aspects, in the present embodiment, the second driver WD2 and the third driver WD3 may be connected to the first driver WD1A. For example, the next write gate signal GW[n+1] may be generated based on a signal of the first write control node WQ and a signal of the second write control node WQB.

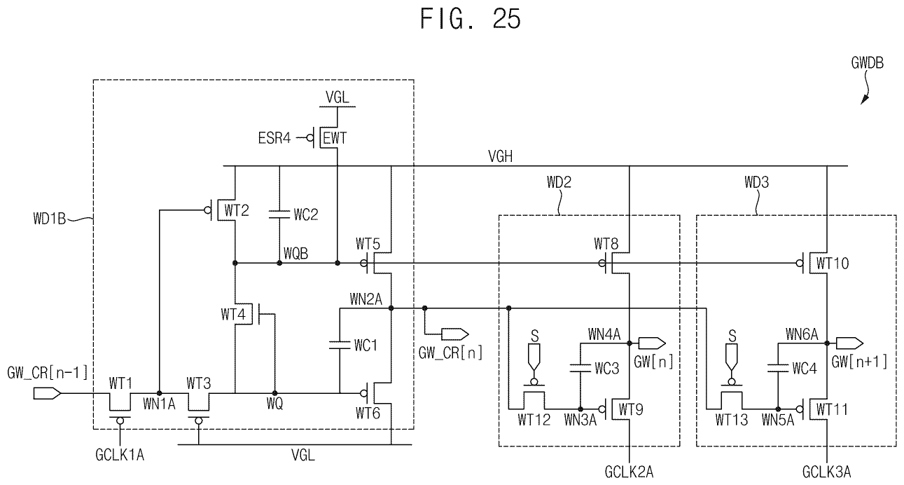

FIG. 25 is a circuit diagram illustrating an example of a write gate signal block included in a gate emission driver 300 of FIG. 1.

A write gate signal block GWDB according to the present embodiment is substantially the same as the write gate signal block GWDA of FIG. 23, except that the write gate signal block GWDB further includes a write power transistor EWT. Accordingly, the same reference numerals will be used to refer to the same and any repetitive explanation concerning the above elements will be omitted.

Referring to FIG. 23 and FIG. 25, in the present embodiment, the write gate signal block GWDB may include the write power transistor EWT. The write power transistor EWT may include a control electrode receiving a fourth power signal ESR4, a first electrode receiving the second power voltage VGL2, and a second electrode connected to the second write control node WQB. The write power transistor EWT may apply the second power voltage VGL to the second write control node WQB in response to the fourth power signal ESR4. Accordingly, the second write control node WQB may be initialized. Accordingly, an output stability of the write gate signal GW[n] and the next write gate signal GW[n+1] may be further improved.

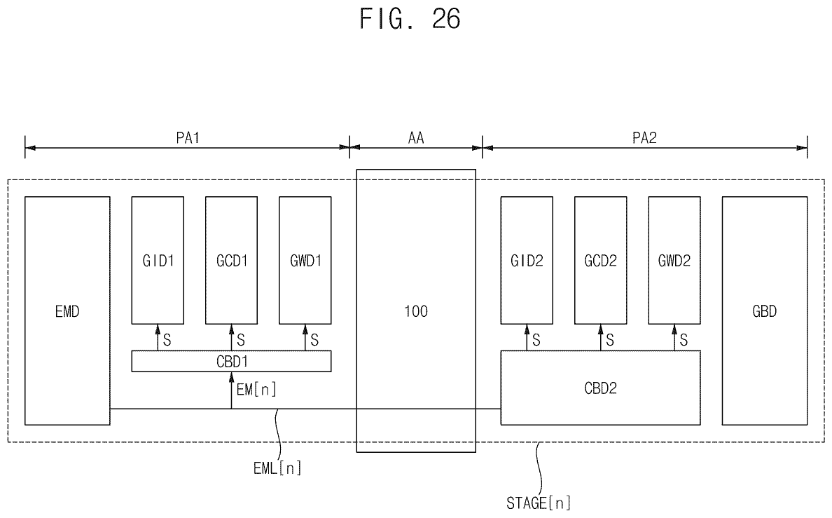

FIG. 26 is a diagram illustrating an example of a location of a display panel 100 and a gate emission driver 300 of FIG. 1.

Referring to FIG. 1 to FIG. 26, in the present embodiment, one stage STAGE[n] of the gate emission driver 300 may be located on a first side PA1 and a second side PA2 different from the first side PA1 of a display region AA. The display panel 100 may include the display region AA. For example, the first side PA1 and the second side PA2 may refer to as a peripheral region of the display panel 100.

In the present embodiment, an emission signal block EMD may generate the emission signal EM[n]. The light emitting element initialization gate block GBD may generate the light emitting element initialization gate signal GB[n].

In the present embodiment, the output control signal block CBD may include a first output control signal block CBD1 and a second output control signal block CBD2. The initialization gate signal block GID may include a first initialization gate signal block GID1 and a second initialization gate signal block GID2. The compensation gate signal block GCD may include a first compensation gate signal block GCD1 and a second compensation gate signal block GCD2. The write gate signal block GWD may include a first write gate signal block GWD1 and a second write gate signal block GWD2.

The emission signal block EMD, the first initialization signal block GID1, the first compensation gate signal block GCD1, the first write gate signal block GWD1, and the first output control signal block CBD1 may be located on the first side PA1.

The light emitting element gate signal block GBD, the second initialization signal block GID2, the second compensation gate signal block GCD2, the second write gate signal block GWD2 and the second output control signal block CBD2 may be located on the second side PA2.

In the present embodiment, the second output control signal block CBD2 may be connected to the emission signal block EMD through an emission line EML[n]. The second output control signal block CBD2 may receive the emission signal EM[n] through the emission line EML[n]. In some aspects, the output control signal block CBD may generate the output control signal S based on the emission signal EM[n] and the enable signal EN. Accordingly, when the second output control signal block CBD2 is located on the second side PA2, the output control signal may be outputted stably.

In some aspects, the emission signal block EMD may not be additionally located on the second side PA2, such that a bezel of the display panel 100 may be reduced.

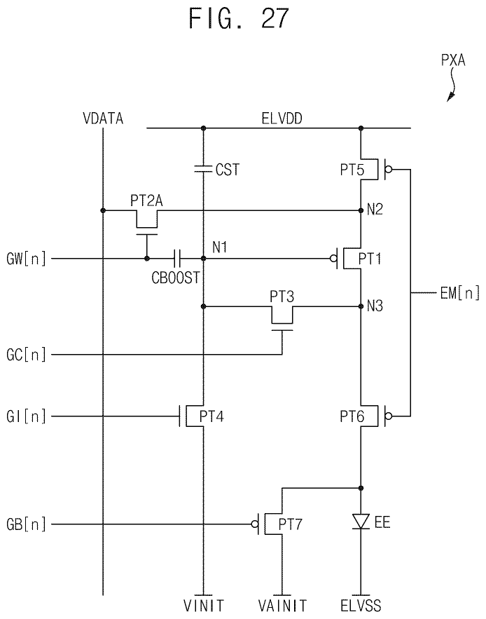

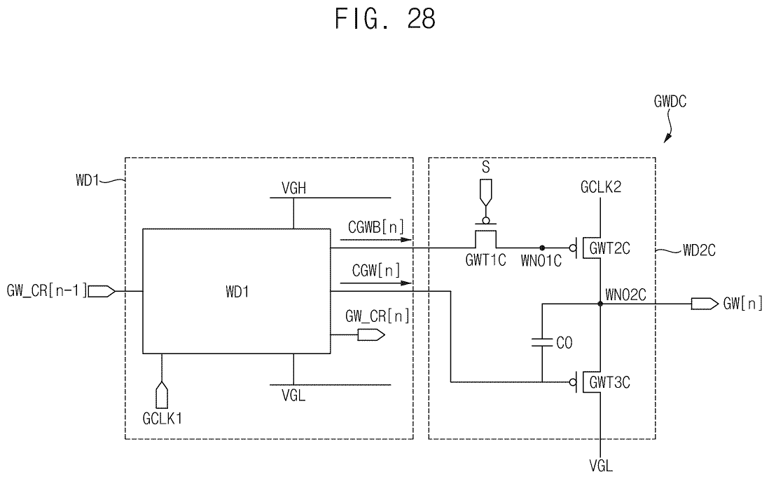

FIG. 27 is a circuit diagram illustrating an example of a pixel included in a display panel of FIG. 1. FIG. 28 is a circuit diagram illustrating a write gate signal block generating a write gate signal applied to a pixel of FIG. 27.

A pixel PXA according to the present embodiment is substantially the same as the pixel of FIG. 2, except that a second pixel transistor PT2A of the pixel PXA is an N-type transistor. Accordingly, the same reference numerals will be used to refer to the same and any repetitive explanation concerning the above elements will be omitted.

In some aspects, a write gate signal block GWDC according to the present embodiment is substantially the same as the write gate signal block GWD of FIG. 17, except that the second driver WD2C is different. Accordingly, the same reference numerals will be used to refer to the same and any repetitive explanation concerning the above elements will be omitted.

Referring to FIG. 17, FIG. 27 and FIG. 28, in the present embodiment, the write gate signal block GWDC may include the first driver WD1 and a second driver WD2C. The second driver WD2C may include a first write output transistor GWT1C, a second write output transistor GWT2C, a third write output transistor GWT3C and a write output capacitor CO. The second pixel transistor PT2 of pixel PXA may be an N-type transistor.

The first write output transistor GWT1C may include a control electrode receiving the output control signal S, a first electrode receiving the second write gate control signal CGWB [n], and a second electrode connected to a first write output node WNO1C. The second write output transistor GWT2C may include a control electrode connected to the first write output node WNO1C, a first electrode receiving a second clock signal GCLK2, and a second electrode connected to a second write output node WNO2C. The third write output transistor GWT3C may include a control electrode the first write gate control signal CGW[n], a first electrode receiving the second power voltage VGL, and a second electrode connected to the second write output node WNO2C. The write output capacitor CO may include a first electrode receiving the first write gate control signal CGW[n] and the second electrode connected to the second write output node WNO2C.

In the present embodiment, the write gate signal block GWDC may output the write carry signal GW_CR[n] and the write gate signal GW[n]. Accordingly, when the output control signal S has an activation level (e.g., a low level), the write gate signal GW[n] may have an inactivation level and the write carry signal GW_CR[n] may have an activation level. Accordingly, the multiple division of the driving frequency may be support. In some aspects, through the multiple division of the driving frequency, the power consumption of the display apparatus may be effectively reduced.

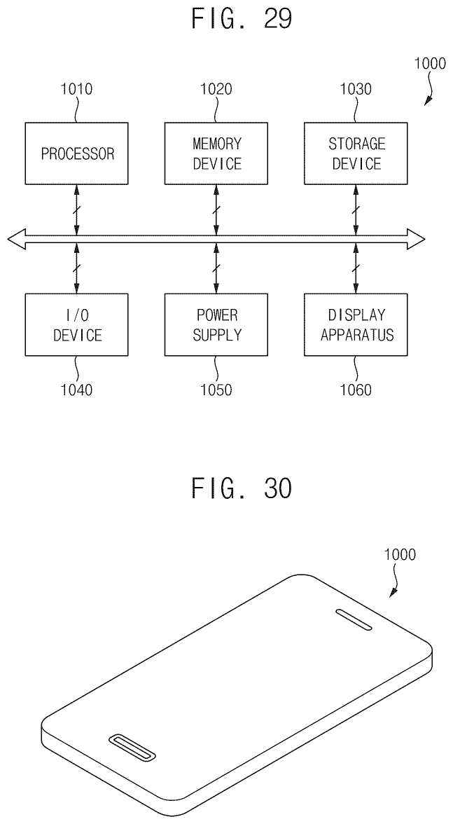

FIG. 29 is a block diagram illustrating an electronic device 1000 according to an embodiment of the present disclosure. FIG. 30 is a diagram illustrating an example in which the electronic device of FIG. 29 is implemented as a smart phone.

Referring to FIG. 29, the electronic device 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In some aspects, the electronic device 1000 may further include a plurality of ports for communicating with a video card, a sound card, a memory card, a universal serial bus (USB) device, other electronic devices, and the like.

In an embodiment, as illustrated in FIG. 30, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, or the like. Further, the processor 1010 may be coupled to an extended bus such as, for example, a peripheral component interconnection (PCI) bus.

The processor 1010 may output the input image data IMG, the app-on signal APPON and the input control signal CONT to the driving controller 200 of FIG. 1.

The memory device 1020 may store data for operations of the electronic device 1000. For example, the memory device 1020 may include at least one non-volatile memory device such as, for example, an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as, for example, a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as, for example, a keyboard, a keypad, a mouse device, a touch-pad, a touch-screen, and the like and an output device such as, for example, a printer, a speaker, and the like. In some embodiments, the display apparatus 1060 may be included in the I/O device 1040. The power supply 1050 may provide power for operations of the electronic device 1000. The display apparatus 1060 may be coupled to other components via the buses or other communication links.

Referring to FIG. 30, the electronic device of the present disclosure is illustrated implemented as a smartphone, but the present inventive concept is not limited thereto. The electronic device may be a television, a monitor, a laptop computer, or a tablet. In some aspects, the electronic device may be a car.

The display apparatus according to the embodiments may be applied to a display apparatus included in a computer, a notebook, a mobile phone, a smart phone, a smart pad, a PMP, a PDA, an MP3 player, or the like.

The foregoing is illustrative of the present disclosure and is not to be construed as limiting thereof. Although example embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. In the claims, means-plus-function clauses may cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A gate emission driver comprising:
a gate signal block; and
an output control signal block configured to control an outputting of the gate signal block,
wherein:
the gate signal block comprises:
a first driver configured to generate a gate control signal and a carry signal based on a previous carry signal; and
a second driver configured to output a gate signal based on the gate control signal in response to an output control signal, and
the output control signal block comprises:
an inverter circuit configured to convert an emission signal to an inverted emission signal; and
an output determining circuit configured to generate the output control signal based on an enable signal, the emission signal, and the inverted emission signal.

2. The gate emission driver of claim 1, wherein:
the output determining circuit comprises:
a first determining transistor comprising a control electrode configured to receive the emission signal, a first electrode configured to receive a first power voltage, and a second electrode connected to a first control node;
a second determining transistor comprising a control electrode configured to receive the enable signal, a first electrode connected to the first control node, and a second electrode connected to a second control node;
a third determining transistor comprising a control electrode configured to receive the enable signal, a first electrode connected to the second control node, and a second electrode connected to a third control node; and
a fourth determining transistor comprising a control electrode configured to receive the inverted emission signal, a first electrode connected to the third control node, and a second electrode configured to receive a second power voltage lower than the first power voltage, and
the first determining transistor and the second determining transistor are each a P-type transistor and the third determining transistor and the fourth determining transistor are each an N-type transistor.

3. The gate emission driver of claim 2, wherein:
the inverter circuit comprises:
a first inverter transistor comprising a control electrode configured to receive the emission signal, a first electrode configured to receive the first power voltage, and a second electrode connected to a fourth control node; and
a second inverter transistor comprising a control electrode configured to receive the emission signal, a first electrode connected to the fourth control node, and a second electrode configured to receive the second power voltage, and
the first inverter transistor is a P-type transistor and the second inverter transistor is an N-type transistor.

4. The gate emission driver of claim 2, wherein the output determining circuit further comprises:
a control capacitor comprising:
a first electrode configured to receive a third power voltage different from the second power voltage; and
a second electrode connected to the second control node.

5. The gate emission driver of claim 1, wherein when the enable signal has a high level and the emission signal has a low level, the gate signal has an activation level.

6. The gate emission driver of claim 5, wherein when the enable signal has the high level and the emission signal has the low level, the output control signal has a low level.

7. The gate emission driver of claim 1, wherein when the enable signal has a low level and the emission signal has a high level, the gate signal has an inactivation level.

8. The gate emission driver of claim 7, wherein when the enable signal has the low level and the emission signal has the high level, the output control signal has a high level.

9. The gate emission driver of claim 1, wherein when the enable signal has a high level and the emission signal has a high level, the output control signal maintains a previous level.

10. The gate emission driver of claim 1, wherein when the enable signal has a low level and the emission signal has a low level, the output control signal maintains a previous level.

11. The gate emission driver of claim 1, wherein:
the gate signal comprises an initialization gate signal,
the second driver comprises:
a first initialization output transistor comprising a control electrode configured to receive the output control signal, a first electrode connected to a second initialization control node, and a second electrode connected to a third initialization node;
a second initialization output transistor comprising a control electrode connected to the third initialization node, a first electrode configured to receive a first power voltage, and a second electrode connected to a fourth initialization node; and
a third initialization output transistor comprising a control electrode connected to a first initialization control node, a first electrode connected to the fourth initialization node, and a second electrode configured to receive a second power voltage lower than the first power voltage, and
a signal of the fourth initialization node is the initialization gate signal.

12. The gate emission driver of claim 11, wherein:
the first driver comprises:
a first initialization carry transistor comprising a control electrode connected to the second initialization control node, a first electrode configured to receive the first power voltage, and a second electrode connected to a second initialization node; and
a second initialization carry transistor comprising a control electrode connected to the first initialization control node, a first electrode connected to the second initialization node, and a second electrode configured to receive the second power voltage, and
a signal of the second initialization node is the carry signal.

13. The gate emission driver of claim 1, wherein:
the gate signal comprises a compensation gate signal,
the second driver comprises:
a first compensation output transistor comprising a control electrode configured to receive the output control signal, a first electrode connected to a second compensation control node, and a second electrode connected to a third compensation node;
a second compensation output transistor comprising a control electrode connected to the third compensation node, a first electrode configured to receive a first power voltage, and a second electrode connected to a fourth compensation node; and
a third compensation output transistor comprising a control electrode connected to a first compensation control node, a first electrode connected to the fourth compensation node, and a second electrode configured to receive a second power voltage lower than the first power voltage, and
a signal of the fourth compensation node is the compensation gate signal.

14. The gate emission driver of claim 13, wherein:
the first driver comprises:
a first compensation carry transistor comprising a control electrode connected to the second compensation control node, a first electrode configured to receive the first power voltage, and a second electrode connected to a second compensation node; and
a second compensation carry transistor comprising a control electrode connected to the first compensation control node, a first electrode connected to the second compensation node, and a second electrode configured to receive the second power voltage, and
a signal of the second compensation node is the carry signal.

15. The gate emission driver of claim 1, wherein:
the gate signal comprises a write gate signal, and the gate control signal comprises a first write gate control signal and a second write gate control signal,
the second driver comprises:
a first write output transistor comprising a control electrode configured to receive the output control signal, a first electrode configured to receive the first write gate control signal, and a second electrode connected to a first write output node;
a second write output transistor comprising a control electrode configured to receive the second write gate control signal, a first electrode configured to receive a first power voltage, and a second electrode connected to a second write output node; and
a third output transistor comprising a control electrode connected to the first write output node, a first electrode connected to the second write output node, and a second electrode configured to receive a second clock signal, and
a signal of the second write output node is the write gate signal.

16. The gate emission driver of claim 15, wherein the first driver generates the gate control signal based on the previous carry signal and a first clock signal different from the second clock signal.

17. The gate emission driver of claim 16, wherein:
the gate signal block further comprises a next write gate signal outputter,
the next write gate signal outputter comprises:
a fourth write output transistor comprising a control electrode configured to receive the output control signal, a first electrode configured to receive the first write gate control signal, and a second electrode connected to a third write output node;
a fifth write output transistor comprising a control electrode configured to receive the second write gate control signal, a first electrode configured to receive the first power voltage, and a second electrode connected to a fourth write output node; and
a sixth write output transistor comprising a control electrode connected to the third write output node, a first electrode connected to the fourth write output node, and a second electrode configured to receive a third clock signal, and
a signal of the fourth write output node is a next write gate signal.

18. A display apparatus comprising:
a display panel comprising a pixel;
a gate emission driver configured to output a gate signal and an emission signal to the display panel; and
a data driver configured to output a data voltage to the display panel,
wherein:
the gate emission driver comprises:
a gate signal block; and
an output control signal block configured to control an outputting of the gate signal block,
the gate signal block is configured to:
generate a carry signal and the gate signal based on a previous carry signal; and
output the gate signal in response to an output control signal, and the output control signal block comprises:
an inverter circuit configured to convert the emission signal to an inverted emission signal; and
an outputting determining circuit configured to generate the output control signal based on an enable signal, the emission signal, and the inverted emission signal.

19. The display apparatus of claim 18, wherein:
the outputting determining circuit comprises:
a first determining transistor comprising a control electrode configured to receive the emission signal, a first electrode configured to receive a first power voltage, and a second electrode connected to a first control node;
a second determining transistor comprising a control electrode configured to receive the enable signal, a first electrode connected to the first control node, and a second electrode connected to a second control node;
a third determining transistor comprising a control electrode configured to receive the enable signal, a first electrode connected to the second control node, and a second electrode connected to a third control node; and
a fourth determining transistor comprising a control electrode configured to receive the inverted emission signal, a first electrode connected to the third control node, and a second electrode configured to receive a second power voltage lower than the first power voltage, and
the first determining transistor and the second determining transistor are each a P-type transistor, and the third determining transistor and the fourth determining transistor are each an N-type transistor.

20. The display apparatus of claim 18, wherein:
the gate emission driver further comprises an emission signal block,
the gate signal block comprises a first gate signal block and a second gate signal block,
the output control signal block comprises a first output control signal block and a second output control signal block,
the emission signal block, the first gate signal block, and the first output control signal block are located on a first side, and
the second gate signal block and the second output control signal block are located on a first side and a second side different from the first side.

21. The display apparatus of claim 20, wherein the emission signal block is connected to the second output control signal block through an emission line.

22. An output control circuit comprising:
an inverter circuit configured to convert an emission signal to an inverted emission signal; and
an outputting determining circuit configured to generate an output control signal based on an enable signal, the emission signal, and the inverted emission signal.

23. The output control circuit of claim 22, wherein:
the outputting determining circuit comprises:
a first determining transistor comprising a control electrode configured to receive the emission signal, a first electrode configured to receive a first power voltage, and a second electrode connected to a first control node;
a second determining transistor comprising a control electrode configured to receive the enable signal, a first electrode connected to the first control node, and a second electrode connected to a second control node;
a third determining transistor comprising a control electrode configured to receive the enable signal, a first electrode connected to the second control node, and a second electrode connected to a third control node; and
a fourth determining transistor comprising a control electrode configured to receive the inverted emission signal, a first electrode connected to the third control node, and a second electrode configured to receive a second power voltage lower than the first power voltage, and
the first determining transistor and the second determining transistor are each a P-type transistor and the third determining transistor and the fourth determining transistor are each an N-type transistor.

24. The output control circuit of claim 22, wherein when the enable signal has a high level and the emission signal has a low level, the output control signal has a low level.

25. The output control circuit of claim 22, wherein when the enable signal has a low level and the emission signal has a high level, the output control signal has a high level.

26. The output control circuit of claim 22, wherein when the enable signal has a high level and the emission signal has a high level, the output control signal maintains a previous level.

27. The output control circuit of claim 22, wherein when the enable signal has a low level and the emission signal has a low level, the output control signal maintains a previous level.

28. An electronic apparatus comprising:
a display panel comprising a pixel;
a gate emission driver configured to output a gate signal and an emission signal to the display panel;
a data driver configured to output a data voltage to the display panel;
a driving controller configured to control the gate emission driver and the data driver based on an input control signal; and
a processor configured to output the input control signal,
wherein:
the gate emission driver comprises:
a gate signal block; and
an output control signal block configured to control an outputting of the gate signal block,
the gate signal block is configured to:
generate a carry signal and the gate signal based on a previous carry signal; and
output the gate signal in response to an output control signal, and
the output control signal block comprises:
an inverter circuit configured to convert the emission signal to an inverted emission signal; and
an outputting determining circuit configured to generate the output control signal based on an enable signal, the emission signal, and the inverted emission signal.
